(19) United States
(12) Patent Application Publication
(10) Pub. No.: US 2009/0142951 A1
(43) Pub. Date: Jun. 4, 2009

(54) Handheld Data-Processing Device and an Accessory Therefor

(76) Inventors: Ah Hock Law, Singapore (SG); Tze Wei Wong, Singapore (SG); Yen Jason Chin, Singapore (SG); Ji Woei Foo, Singapore (SG)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/063,880

(22) PCT Filed: Aug. 16, 2005
(86) PCT No.: PCT/SG2005/000277

§ 371 Date: Feb. 15, 2008

(51) Int. Cl. H01R 13/28

(52) U.S. Cl. 439/287

(57) ABSTRACT

A handheld data-processing device in the form of a personal digital assistant (PDA) (10) for use in an industrial environment includes an expansion module (100) arranged to be releasably fixed to a rear face of the PDA (10) and so as to be operatively coupled thereto. Each of the PDA (10) and the expansion module (100) includes a respective data communications connector (50, 150). Each connector (50, 150) is the same as the other connector (50, 150). Each connector (50, 150) includes two parallel rows of terminals (60, 70), with the terminals (60) of the first row projecting further from the remainder of the connector (50, 150) that the connectors (70) of the second row. The terminals (60) of the first row in each connector (50, 150) are for connecting with the connectors (70) of the second row in the respective other connector (50, 150) when the two connectors (50, 150) are brought together. Supporting structure of each connector (50, 150) is insert moulded around the terminals (60, 70) to create a seal therebetween. The module (100) is accommodated in a recess in the PDA (10) to provide positive location therebetween.

### FIELD OF THE INVENTION

This invention relates to handheld data processing devices and to accessories for use therewith. In particular, this invention relates to personal digital assistants.

### BACKGROUND TO THE INVENTION

Personal digital assistants (PDAs) are handheld, portable, computing devices that provide at least some of the features of a conventional desktop personal computer. Such devices are intended to be of use to those who are not able, or for whom it is inconvenient to access a conventional desktop personal computer. Certain PDAs include one or more expansion interface. The expansion interfaces are for receiving an expansion accessory by connecting a -connector of the accessory to a mating connector of the expansion interface such that the accessory is able to communicate with the PDA and add to the PDA's existing features. For example, the interface may be a universal serial bus (USB) interface with a female USB connector and the accessory may be a USB Wireless transceiver with a male USB connector that plugs into the female connector to add a wireless communications feature to the PDA. As another example, the interface maybe a PCMCIA interface and the accessory may be a PCMCIA memory card that plugs into the interface and increases the memory, capacity of the PDA.

A form of PDA is also used in industrial environments, such as manufacturing facilities and industrial storage facilities. This form of PDA will hereinafter be referred to as an “industrial PDA”. In facilities such as these, industrial PDAs are used for tasks such as recording operational data from manufacturing machines and for stock control purposes. The environment in which industrial PDAs are used is therefore a much harsher environment than that to which a conventional PDA might be exposed. The industrial PDA is likely to be exposed to corrosive materials, airborne particles and contaminants; and mechanical impact, vibration and wear. As a result, industrial PDAs must be of more rugged design that conventional PDAs if they are to be of use.

Expansion accessories for coupling to a PDA by way of a USB, PCMCIA or similar interface are therefore unsuited to use with an industrial PDA: such accessories can easily become disconnected from the industrial PDA if they are knocked or the PDA is dropped during use, and may even break or become damaged at the point at which they connect to the PDA. The interface between the PDA and such accessories is also such that it tends not to guard against the ingression of extraneous material such as liquids and airborne particles into the PDA and the expansion accessory.

One-way in which the suitability of industrial PDAs to their intended environment can be indicated is by way of an ingression protection (IP) rating. This rating is a measure of the degree of protection a PDA has against the ingression of liquids and particles. PDAs can also be assessed in terms of the height of a vertical drop which the PDA can survive without substantial damage. It will therefore be appreciated that PDAs with expansion accessories fitted thereto by way of interfaces such as the USB and PCMCIA interface tend not to score well in such tests.

It is an object of this invention to provide a handheld data-processing device that is arranged to receive an expansion accessory in a manner that is suited to use in an industrial environment.

### SUMMARY OF THE INVENTION

According to one aspect of this invention, there is provided a handheld data-processing device and an accessory therefor, each of the device and the accessory having a respective data communications connector for connecting the device and the accessory together for data communication therebetween, wherein each connector is substantially the same as the respective other connector, having electrical terminals of substantially the same shape and arrangement as the terminals of the respective other connector, and further arranged such that each terminal of each connector is arranged to contact a respective terminal of the respective other connector when the device and the accessory are connected together.

By providing the handheld data-processing device with a connector that can connect with a like connector, the usual male-to-female type of connection is dispensed with. Thus, the problems associated with have an accessory fixed to the device in a cantilevered manner, that is with one end inserted into a female socket, are avoided. Instead, embodiments of the present invention may use a lower profile, face-to-face connection between an accessory and a device. As there is no male-to-female connection with the connector of the present invention, the present connector may be thought of as an “hermaphroditic” connector.

According to a second aspect of this invention, there is provided a handheld data-processing device having a data communications connector for connecting the device to an accessory for data communication therewith, wherein the connector of the device is arranged so as to connect to another connector that is substantially the same, with electrical terminals of substantially the same shape and arrangement as terminals of the connector of the device.

According to a third aspect of this invention, there is provided an accessory for a handheld data-processing device, the accessory having a data communications connector for connecting the accessory to the device for data communication therewith, wherein the connector of the accessory is arranged so as to connect to another connector that is substantially the same, with electrical terminals of substantially the same shape and arrangement as terminals of the connector of the accessory.

Preferably, the handheld data-processing device is a computing device; and may be, for example, a laptop computer, a portable digital assistant or a tablet computer. The handheld data-processing device may be, or may additionally be, a communications device; such as, for example, a cellular telephone, a smartphone

Preferably, each connector includes resiliently-deformable projecting terminals that are each arranged to contact a respective terminal of the respective other connector when the two connectors are connected together.

Preferably, each connector includes a first group of terminals that projects further from the remainder of the connector than a second group of terminals of the connector.

Preferably the groups of terminals are arranged such that each group of each connector contacts the respective other group of the respective other connector when the two connectors are connected together. The two groups of terminals and/or the device and the accessory may be, arranged such that the accessory and the device may be brought together in a preferred direction substantially perpendicular to the direction of projection of the terminals, such that the second group of terminals of each connector relatively pass over the second group of the respective other connector without making contact, before being brought into contact with the first group of the respective other connector.

By avoiding contact between the second group of terminals of the accessory and the second group of terminals of the device, undesirable connections that may lead to short-circuits ban be avoided.

The first group of terminals may be arranged on the connector into a respective first series and the second group maybe arranged on the connector into a respective second series, with thee two series running substantially along side one another. Preferably, for each connector, the second series made up of the second group is arranged closest to a preferred direction from with the respective other connector is brought towards the connector for connection therebetween. Preferably, the first group is arranged into a first row and the second group is arranged into a second row, and preferably the two rows are substantially parallel and preferably substantially perpendicular to the preferred direction from which the respective other connector is introduced.

The first group of terminals may be resiliently-deformable upon contact with the second group of the respective other connector.

Preferably each of the device and the accessory have respective cooperating structure that ensures that the accessory is in a desired position relative to the device when the device and the accessory are connected together, such that each connector contacts the other for data communication therebetween. The cooperating structure on each of the device and the accessory may guide the accessory into the desired position when the device and the accessory are brought together. The cooperating structure nay include guide rails on one or both of the device and the accessory for cooperating with structure on the respective other of the device and the accessory, such that the accessory can be slid into the preferred position relative to the device. Preferably, the cooperating structure is arranged so as to cause the device and the accessory to approach one another from the respective preferred direction. One or both of the device and the accessory may include a connecting structure to releasably hold the two together with the accessory in the desired position. The connecting structure may include a latch mechanism. The connecting structure may include a locking mechanism to guard against separation of the device and the accessory.

Each connector may include supporting structure through which each of the terminals of that connector projects, the terminals extending from an inner side of the supporting structure that is for communication with an inside of the device or accessory to an outer side that is exposed for contact with the respective other connector. Preferably the supporting structure creates a seal around each terminal projecting therethrough. Preferably the seal is liquid-tight and/or air-tight. Preferably the seal is formed by the supporting structure being insert moulded around the terminals. The supporting structure may be plastic and may be substantially planar. Additional supporting structure may be ultrasonically welded to the supporting structure to at least partially enclose at least some of the terminals.

The connector may be arranged such that the parts of the terminals that extend to the inner side of the supporting structure are resiliently deformable such that the connector may be positioned against other terminals, such as traces of a printed circuit board (PCB) with those parts of the terminals pressed against the other terminals so as to maintain good contact therewith. Thus soldered connections between the terminals of the connector and other terminals may be avoided.

Preferably, the device includes a recess formed in the body thereof that is shaped to accommodate the accessory therein such that the accessory abuts walls of the recess and does not substantially protrude beyond the external contours of the body. Preferably, a mouth of the recess is at an end of the device such that the accessory maybe slid into the recess via the mouth. Preferably, the recess is formed such that the accessory is slid into the recess in a preferred direction that is in the plane of the device.

Preferably, the releasable connecting means acts to resist the accessory being withdrawn from the device in the reverse direction to the preferred direction.

Preferably, the cooperating structure is arranged to resist the accessory being withdrawn from the device in a direction perpendicular to the plane of the device.

According to a fourth aspect oft is invention, there is provided an connector as defined herein.

According to a fifth aspect of this invention there is provided a method of manufacturing a connector as defined herein, the method including the step of insert moulding supporting structure of the connector around the terminals thereof to create a seal between the terminals and the supporting structure.

According to a sixth aspect of this invention there is provided and device and/or an accessory as defined herein, each being without the connector.

### BRIEF DESCRIPTION OF THE DRAWINGS

Specific embodiments of this invention are described below by way of example only and with reference to the accompanying drawings, in which:

FIG. 1 is a front view of a personal digital assistant (PDA);

FIG. 2 is a perspective view of the PDA and of an accessory therefor, a rear face of the accessory being shown;

FIG. 2A is a perspective view of the accessory for the PDA; a front face of the accessory being shown;

FIG. 3 is a sectional view of insert moulding apparatus used to mould a plate of a connector for the PDA and accessory, the section being perpendicular to the plate;

FIG. 4A is a perspective view of the connector without a support block fitted thereto;

FIG. 4B is a sectional view of the connector without the support block fitted thereto, the section being perpendicular to the plate;

FIG. 5 is a perspective view of the connector with the support block being fitted thereto;

FIG. 6 is a perspective view of the connector with the support block fitted thereto;

FIG. 7 is a perspective view of the inside of a rear part of casing of the PDA;

FIG. 8 is a sectional view of the connector and a printed circuit board (PCB), the section being perpendicular to the plate of the connector and the PCB;

FIG. 9 is a sectional view of the PDA and of the accessory, the accessory being slid into position in a recess of the PDA, and the section being perpendicular to the plane of the PDA and the accessory;

FIG. 10 is the same sectional view as FIG. 9, but with the accessory fitted into position in the recess of the PDA; and

FIG. 11 is a rear elevation view of the PDA with the accessory fitted thereto.

### SPECIFIC DESCRIPTION OF CERTAIN EXEMPLARY EMBODIMENTS

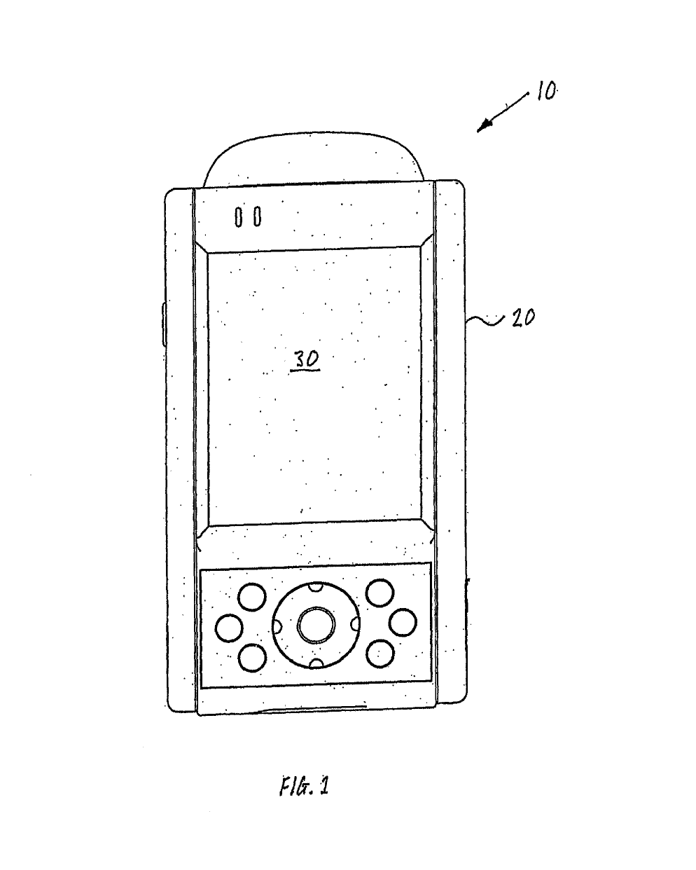

FIG. 1 shows a handheld data-processing device in the form of a personal digital assistant (PDA) 10 for use in an industrial environment, i.e. an “industrial PDA”. The PDA 10 is shaped as a generally rectangular slab or tablet that is of a size which allows it to be gripped in a user's hand. A front face of the PDA 10 has a graphical display in the form of a display screen 30 mounted therein. The display screen 30 is touch sensitive and in use acts as a graphical user interface. The PDA 10 has a plastic casing that is designed to assist in protecting components of the PDA 10 from damage when the PDA 10 is subject to mechanical shocks, such as those resulting from the PDA 10 being dropped. The plastic casing 20 fits around the components of the PDA 10 so as to resist the ingress of extraneous matter.

As can be seen from FIG. 2, a rear face of the PDA 10 has a wide, shallow, recess 40 formed therein. A connector 50 of a communications interface is mounted in the recess 40. The recess 40 is arranged to receive an accessory for the PDA 10 in the form of an expansion module 100. The PDA 10 and the module 100 are arranged such that the module 100 can slot into the recess 40 formed in the rear face of the PDA such that the connector 50 in the recess 40 makes contact with another connector (shown only in to FIG. 2A) mounted in the module 100, thereby allowing communication between the PDA 10 and the module 100. The two connectors 50, 150 are the same as each other.

A method of manufacturing the connectors 50, 150 will now be described. This will be followed by a description of the way in which the connector 50 is accommodated in the PDA and the connector 150 is accommodated in the module 100. A description of the way in which the module 100 slots into the PDA 10 for data communication therebetween will then follow.

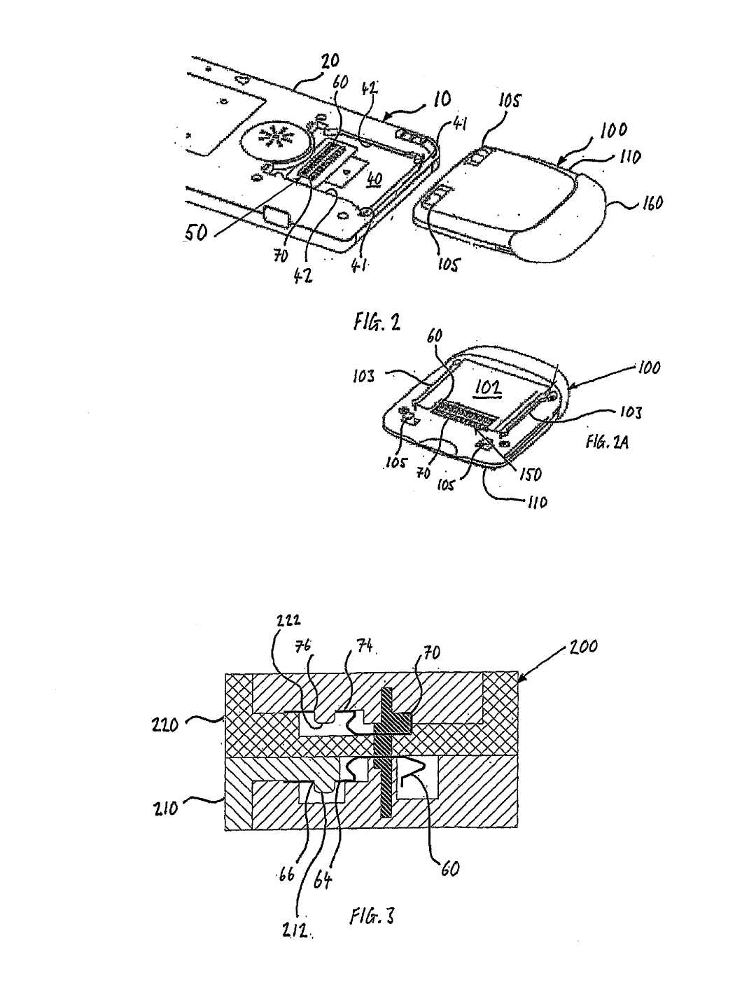

FIG. 3 is a cross sectional view of insert moulding apparatus 200 used in manufacturing the connectors 50, 150. As each connector 50, 150 is the same, or at least substantially the same, as the other, the manufacture of a single connector 50 will be described. The insert moulding apparatus 200 includes several mating parts. The insert moulding apparatus includes a first part 210 that holds a first set of terminals 60 of the connector 50. In this exemplary embodiment, there are eleven terminals in the set. The first set of terminals 60 are in the form of a series of strips of beryllium copper, each bent into a C-shape and each joined at a one end of the C to a web 64 of the same material. Each of the C-shaped terminals 60 lies in a respective plane that is perpendicular to the plane of the web and parallel to the plane of each other C-shaped terminal 60. The web 64 includes an aperture 66 formed therein. The first part 210 of the insert moulding apparatus 200 includes a spigot 212 that is sized to fit through the aperture 66 in the web 64 so as to hold the first set of terminals 60 thereon.

A second part 220 of the insert moulding apparatus 200 holds a second set of eleven terminals 70 thereon. The second set of terminals 70 is the same as the first set 60 in that each terminal 70 is a C-shaped strips 70 of beryllium copper attached to a web 74 having an aperture 76 therethough by which the terminals 70 are fitted to a spigot 222 of the second part 220 of the insert moulding apparatus 200. However, the first C-shaped terminals 60 and the second C-shaped terminals differ. The second C-shaped terminals 70 each have a flattened end furthermost from the web 74 to which they are attached, whereas the first C-shaped terminals 60 each have an outwardly-pointed and V-shaped end furthermost from the web 64 to which they are connected.

Although it is preferred that the terminals 60, 70 be of beryllium copper in this embodiment, it is envisaged that other materials suitable for forming an electrical contact terminal may be used. For example, in other embodiments, the terminals 60, 70 may be of phosphorous bronze.

During an insert moulding operation, each of the first and second terminals 60, 70 are held by the respective first and second parts 210, 220; and other parts of the insert moulding apparatus are positioned around the terminals 60, 70 to form a moulding cavity 250 that extends from one end of each series of C-shaped strips 60, 70 to the other. Plastic material is then injected into the cavity 250.

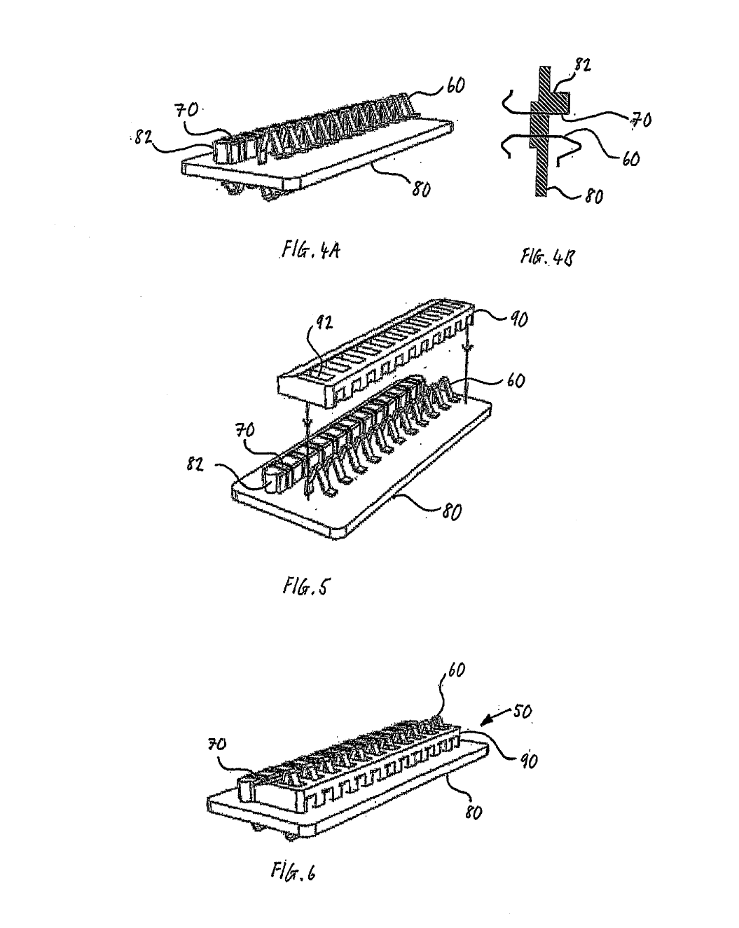

When the moulding operation has been completed, the first and second terminals 60, 70 are withdrawn from the moulding apparatus 200 and the webs 64, 74 are trimmed off to leave discrete C-shaped terminals 60, 70. Thus, the arrangement is one of two parallel rows of generally C-shaped beryllium copper terminals embedded in a substantially rectangular plastic plate 80. This arrangement is shown in FIG. 4A and FIG. 4B. The rows of C-shaped terminals 60, 70 are embedded so as to be back-to-back and such that their openings face away from one another. The rounded end of each C-shaped terminal 60, 70 extends below a bottom face of the plate 80; and the opposite flattened ends of the second terminals 70 extend above a top face of the plate, together with the pointed ends of the first terminals 60. It should be noted, however, that the plate 80 is not quite planar and instead includes a projecting ridge 82 that extends from the top face of the plate 80 to contact the underside of the flattened end of each of the second terminals 70 and thereby to support those flattened ends.

With reference to FIG. 5, a support block 90 that has a respective slot 92 therein to accommodate the top part of each of the first terminals 60 that projects above the plate 80 is placed over the first terminals 60. When placed over the first terminals 60 in this way, the pointed ends of those terminals 60 project beyond the support block 90. The support block 90 is then ultrasonically welded to the plate 80, to result,in the arrangement shown in FIG. 6. This completes the manufacture of the connector 50.

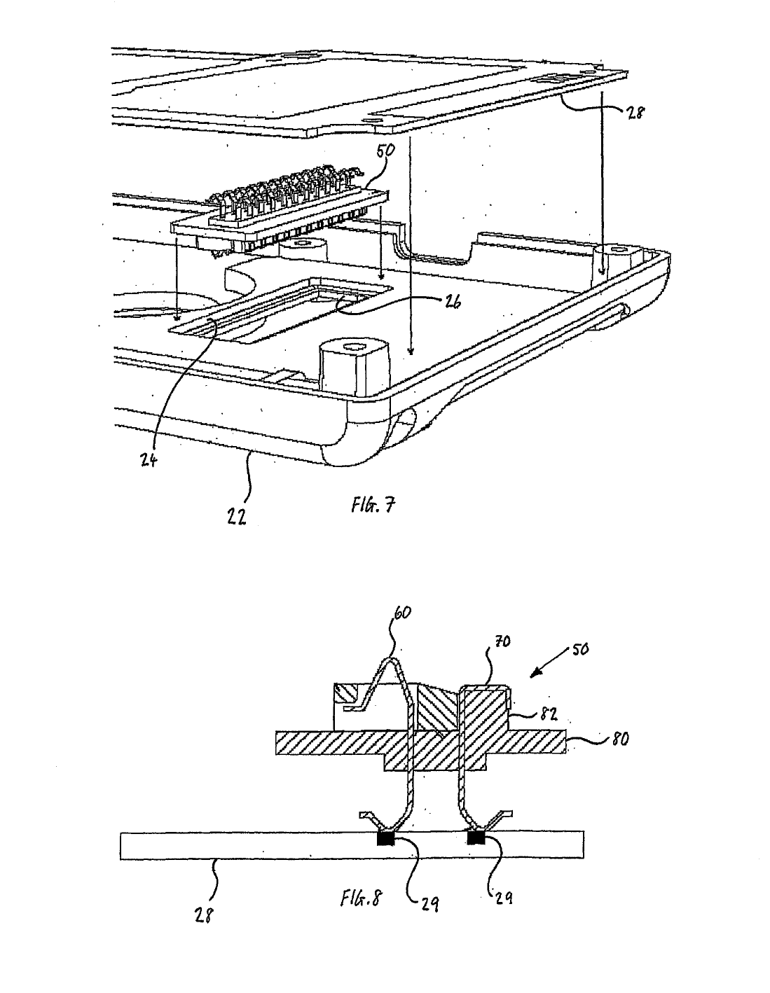

FIG. 7 shows a rear half 22 of the plastic casing 20 of the PDA 10. A rectangular recess 24 that is sized to receive plate 80 of the connector 50 is formed in the rear casing 22. A rectangular aperture 26 is formed in the centre of the recess 24 and is sized to as to allow the support block 90, the ridge 82 and the first and second terminals 60, 70 of the connector 50 to project therethrough. The connector 50 is placed in the recess 24 in the rear casing 22 accordingly with the parts of the connectors 60, 70 that project above the plate 80 projecting therethrough from the inside of the casing 22 to the outside. The connector 50 is fixed in position in the recess 24 by ultrasonically welding the periphery of the plate 80 of the connector to surrounding structure of the rear half 22 of the casing 20 of the PDA 10. It is envisaged that techniques other than ultrasonic welding maybe used for creating a seal between the connector 50 and the casing 20 of the PDA 10. For example, the periphery of the plate 80 maybe glued to the surrounding structure of the rear half 22 of the casing 20, or maybe sealed thereto using a gasket.

A printed circuit board (PCB) 28 of the PDA 10 is then placed over the bottom of the connector 50 and against the inside of the rear casing 22. As is shown in FIG. 8, when the PCB 28 is fixed in position, electrical contact terminals 29 of the PCB 28 are positioned below and in contact with the rounded lower part of each of the terminals 60, 70 of the connector 50 that extend beneath the plate 80. The PCB 28 is positioned such that the terminals 29 thereof press against and slightly deflect the terminals 60, 70 of the connector 50.

Assembly of the PDA 10 is completed by fixing a front half of the PDA casing 20 to the rear half 22.

With reference again to FIG. 2, it can be seen that, when assembly has been completed, the connector 50 is positioned in the recess 40 that is formed in the rear face of the PDA 10 The recess 40 is formed at the top end of the rear face of the PDA 10, the top of the PDA being the end thereof adjacent the top of the display screen 30 during normal use. Sides 41 of the recess 40 are parallel to the sides of the PDA 10 and each includes a projecting rail 42 running therealong. The rails 42 project towards one another so as to overhang the recess. At an end of each rail 42 that is remote from the top of the PDA 10, each rail 42 includes a saw-tooth shaped projection that projects towards the other rail 42 across the recess so as to form a respective catch 44. Together, the recess 40 and the rails 42 form a slot, a mouth of which opens at the top of the PDA 10.

As can also be seen from FIG. 2, the expansion module 100 is generally rectangular in plan form and has a thickness similar to that of the PDA 10. The connector 150 of the module 100, which as stated above is the same as the connector 50 mounted in the PDA 10, is manufactured and mounted in casing 110 of the module 100 is generally the same way as the connector 50 of the PDA 10 is manufactured and mounted in the PDA 10. The connector 150 in the module 100 is only visible in FIG. 2A.

With continued reference to FIG. 2A, it can be seen that the face of the module 100 in which the connector 150 is mounted and projects through is different to the rear face of the PDA 10. Specifically, this face of the module 100 includes a raised spigot portion 102 shaped to be a sliding fit in the recess 40 in the rear face of the PDA 10. The spigot portion 102 includes outwardly-projecting rails 103, each running along a respective one of a pair of opposite edges of the raised spigot portion 102. The rails 103 of the module 100 are arranged to be a sliding fit beneath the rails 42 in the recess in the rear face of the PDA 10.

The module also includes two latch mechanisms 104. Each latch mechanism 104 includes a finger 105 that extends through the casing 110 of the module 100 to project therefrom on the same side as the connector 150 and the spigot portion 102. Each finger 105 is adjacent an end of a respective one of the rails 103 and is positioned in a respective slot 106 so as to be moveable towards the other finger 105 against a respective spring (not shown). As can be seen in FIG. 2, a back portion of each finger 105 is accessible on the side of the module 100 that does not include the connector 150. The back portion of each finger 105 is formed into a user-engageable slider that can be engaged by a user to slide the finger 105 in the slot 106 against the spring.

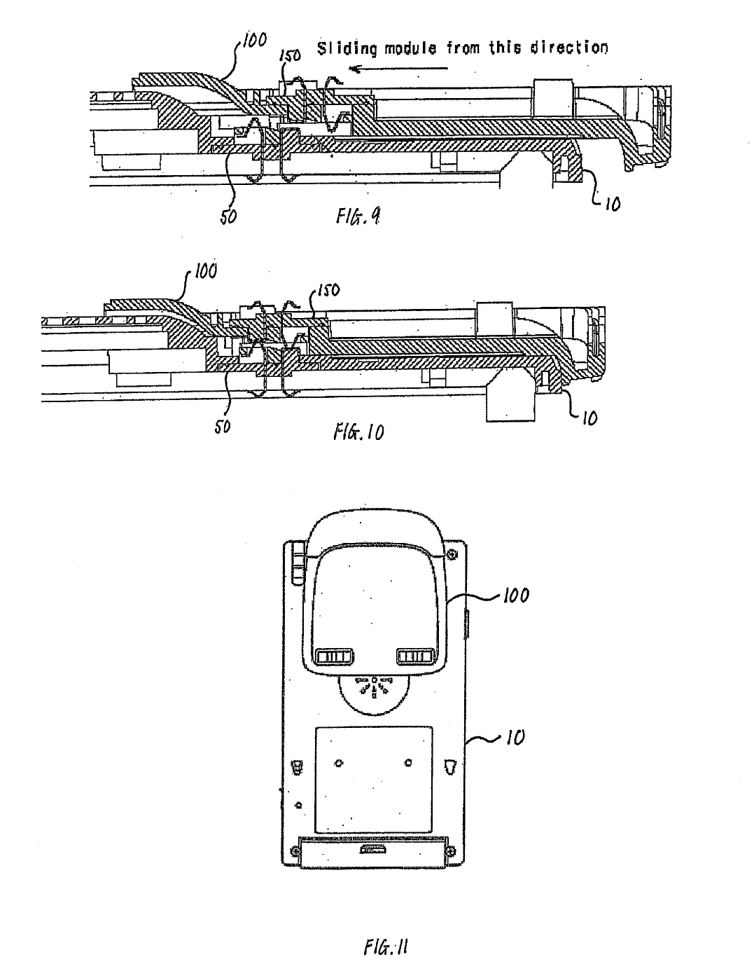

In order to connect the expansion module 100 to the PDA 10, the module 100 is moved towards the mouth of the recess 40 in the PDA 10 such that the rails 103 of the module 100 are inserted beneath the rails 42 in the recess 40. The module 100 is then slid towards the PDA 10 such that it is slotted into the recess 40. As the, module 160 is slotted into the recess 40, the connector 150 of the module 100 approaches the connector 50 of the PDA 10. This is shown in FIG. 9. With continued reference to FIG. 9, it can be seen that the orientation of the connector 50 in the PDA 10 and the connector 150 in the module 100 are such that the second-terminals 70 of each connector 50, 150 relatively approach one another, before the first terminals 60 relatively approach one another. As the parts of the second connectors 70 that are exposed are the flattened, the second terminals 70 of each connector 50, 150 are able to approach and pass over one another without coming into contact. In this way, potentially damaging short circuits between the second terminals 70 of the connector 50 of the PDA and the second terminals 70 of the connector 50 of the module 100 are avoided.

Continuing to push the module 100 as far as possible along the length of the slot formed by the recess 40 causes the second terminals 70 of the connector 150 in the module 100 to approach the first terminals of the connector 50 in the PDA 10; and the first terminals 60 of the connector 150 in the module 100 to approach the second terminals of the connector 50 in the PDA 10. This is shown in FIG. 10. As the first terminals 60 all project in a pointed V-shape from the-remainder of the respective connector 50, 150 of which they are part, the flattened second terminals 70 of each connector 50, 150 contact the first terminals 60 of the other connector 50, 150. The overall arrangement is such that the flattened second terminals 70, which are supported by the edge 82, press on and deflect slightly the first terminals 60 which are not supported and so are free to be deflected. In this way, each of the terminals 60, 70 of one connector 50, 150 contacts a respective terminal 60, 70 of the respective other connector 50, 150. When the module 100 is slid into this position in which the two connectors 50, 150 contact one another, each of the fingers 105 of the module 100 latches over a respective one of the catches 44 formed at the ends of the rails 43 in the recess 40, and thereby releasably fixes the module 100 in position oh the back face of the PDA. In this position data communication is possible between the PDA 10 and the module 100 by way of the mating connectors 50, 150. FIG. 11 shows the module 100 fixed in position in the recess 40 in the rear face of the PDA 10.

When the expansion module 100 is attached to the PDA 10 in this way, there is secure attachment between the two. This secure attachment is provided by the rails 103, which extend across a large part of the module 100 being held under the cooperating rails 43 in the recess 40 on the rear face of the PDA 10; and by the two latch mechanisms 104, each latching over a respective one of the catches 44 in the recess 40. In addition, it should be understood that the module 100 substantially fits into the recess 40 in the rear face of the PDA 10, within the external contours of the PDA 10, and such that one end and two sides of the module 100 each abut a respective wall of the recess 40 in the rear face of the PDA 10. Again, this serves to assist in keeping the module 100 in position.

Thus, should the PDA 10 with the expansion module 100 attached thereto be dropped during operation or subject to other mechanical shocks, the expansion module 100 tends not to become dislodged from the position in which it is connected to the PDA 10. In addition, because the terminals 60, 70 of the connectors 50, 150 are not soldered to the PCBs for which they act as connectors, but instead are pressed thereagainst, electrical connection between the terminals 60, 70 and the PCBs tends not to be lost when the PDA 10 is subject to mechanical shock.

It should also be understood that, with the connector 50 fitted into place in the recess 40 of the PDA 10, there is no aperture that connects the inside of the PDA 10 with the outside environment. In particular, there is no such aperture through the connector 50 because the terminals 60, 70 of the connector 50 are insert moulded in the plate 80 of the connector 80. Similarly, there is no aperture through material of the expansion module 100 that connects the inside of the module 100 with the outside world. The absence of an aperture that connects the inside of either the PDA 10 or the expansion module 100 with the surrounding environment guards against the ingress into the PDA 10 and the module 100 of unwanted material, such that corrosive particles or liquids.

Should the PDA 10 with the expansion module 100 attached thereto be dropped during operation, the fixation of the aerial 120 to the casing 110 of the module 100 (instead of, for example, to the PCB therein) guards against the aerial 120 coming free and becoming damaged or damaging any other component in the casing 110 of the module 100.

The expansion module 100 shown in FIG. 2 also includes an expansion card slot (not shown) and an associated interface (not shown) for receiving an expansion card such as, for example, a memory card or PCMCIA card, and for providing for communication between such a card and components of the expansion module 100. The slot is formed in an end of the module 100. As is shown in FIG. 2, a dustproof and waterproof cap 160 is provided. The cap 160 is formed from an elastomeric material and is shaped so as to cover the end on module 100 in which the expansion card slot is formed. The cap 160 acts as a cover for the expansion card slot so as to keep unwanted material out of that slot and out of the module 100.

In an alternative embodiment, a shock-absorbing material that is electrically conductive may be placed between the terminals 60, 70 and the conductors of the PCBs with which the terminals 60, 70 are in contact. The shock-absorbing material may be attached to, or form part of, the terminals 60, 70 and/or may be attached to or form part of the conductors of the PCBs. In use, the shock-absorbing material acts to absorb shock resulting from the PDA being knocked or dropped such that damage to the terminals 60, 70 and the PCB conductors tends to be avoided and such that contact therebetween tends to be maintained. The sock-absorbing material may be a resiliently-deformable material such as a conductive elastomeric compound.

That which is claimed:

1. A handheld data-processing device and an accessory therefor, each of the device and the accessory comprising a respective data communications connector for connecting the device and the accessory together for data communication therebetween, wherein each connector is substantially the same as the respective other connector, having electrical terminals of substantially the same shape and arrangement as the terminals of the respective other connector, and further arranged such that each terminal of each connector is arranged to contact a respective terminal of the respective other connector when the device and the accessory are connected together.

2. A handheld data-processing device comprising a data communications connector for connecting the device to an accessory for data communication therewith, wherein the connector of the device is arranged so as to connect to another connector that is substantially the same, with electrical terminals of substantially the same shape and arrangement as terminals of the connector of the device.

3. An accessory for a handheld data-processing device, the accessory comprising a data communications connector for connecting the accessory to the device for data communication therewith, wherein the connector of the accessory is arranged so as to connect to another connector that is substantially the same, with electrical terminals of substantially the same shape and arrangement as terminals of the connector of the accessory.

4. A device and accessory according to claim 1, wherein each connector includes resiliently-deformable projecting terminals that are each arranged to contact a respective terminal of the respective other connector when the two connectors are connected together.

5. A device and accessory according to claim 1, wherein each connector includes a first group of terminals that projects further from the remainder of the connector than a second group of terminals of the connector.

6. A device and accessory according to claim 5, wherein the groups of terminals are arranged such that each group of each connector contacts the respective other group of the respective other connector when the two connectors are connected together.

7. A device and accessory according to claim 5, wherein the two groups of terminals and optionally the device and accessory are arranged such that the accessory and the device may be brought together in a preferred direction substantially perpendicular to the direction of projection of the terminals, such that the second group of terminals of each connector relatively pass over the second group of the respective other connector without making contact, before being brought into contact with the first group of the respective other connector.

8. A device and accessory according to claim 5, wherein the first group is arranged into a first row and the second group is arranged into a second row, and preferably the two rows are substantially parallel and preferably substantially perpendicular to the preferred direction from which the respective other connector is introduced; and wherein, for each connector, the second row made up of the second group is arranged closest to a preferred direction from with the respective other connector is brought towards the connector for connection therebetween.

9. A device and accessory according to claim 5, wherein the first group of terminals is arranged so as to be resiliently-deformable upon contact with the second group of the respective other connector.

10. A device and accessory according to claim 1, wherein each of the device and the accessory has respective cooperating structure that guides the accessory into a desired position relative to the device in which each connector contacts the other for data communication therebetween, when the device and the accessory are brought together.

11. A device and accessory according to claim 10, wherein the cooperating structure includes guide rails on at least one of the device and the accessory for cooperating with structure on the respective other of the device and the accessory, such that the accessory is configured to slide into the desired position relative to the device.

12. A device and an accessory according to claim 10, wherein the two groups of terminals and optionally the device and accessory are arranged such that the accessory and the device may be brought together in a preferred direction substantially perpendicular to the direction of projection of the terminals, such that the second group of terminals of each connector relatively pass over the second group of the respective other connector without making contact, before being brought into contact with the first group of the respective other connector, and further wherein the cooperating structure is arranged so as to cause the device and the accessory to approach one another from the respective preferred direction.

13. A device and accessory according to claim 1, wherein at least one or both of the device and the accessory includes releasable connecting means to releasably hold the two together with the accessory in the desired position.

14. A device and accessory according to claim 13, wherein the releasable connecting means includes a latch mechanism.

15. A device and accessory according to claim 1, wherein each connector includes supporting structure through which each of the terminals of that connector projects, the terminals extending from an inner side of the supporting structure that is for communication with an inside of one of the device and accessory to an outer side that is exposed for contact with the respective other connector, the supporting structure creating a seal around each terminal extending therethrough.

16. A device and accessory according to claim 15, wherein the supporting structure is sealed to the remainder of at least one of the device and the accessory such that the ingress of extraneous matter into at least one of the device and the accessory is avoided.

17. A device and accessory according to claim 15, wherein at least part of the supporting structure is insert moulded around the terminals, thereby creating the seals therebetween.

18. A device and accessory according to claim 15, wherein each connector includes a first group of terminals that projects further from the remainder of the connector than a second group of terminals of the connector, and further wherein the supporting structure includes additional supporting structure that supports each of the terminals of the second group in a preferred position relative to the supporting structure.

19. A device and accessory according to claim 15, wherein each connector is arranged such that the parts of the terminals that extend to the inner side of the supporting structure are resiliently deformable such that the connector may be positioned against other terminals and those parts of the terminals of the connectors pressed against the other terminals so as to maintain good contact therewith.

20. A device and accessory according to claim 1, wherein the device includes a recess formed in the body thereof that is shaped to accommodate the accessory therein such that the accessory abuts walls of the recess and does not substantially protrude beyond the external contours of the body.

21. A device and accessory according to claim 1, wherein the device is a personal digital assistant (PDA).
